(19) United States
(12) Patent Application Publication
(10) Pub. No.: US 2026/0330002 A1
(43) Pub. Date: Oct. 22, 2026

(54) ELECTRONIC DEVICE, METHOD, AND NON-TRANSITORY COMPUTER READABLE STORAGE MEDIUM FOR IDENTIFYING INTEGRITY OF STORED DATA

(71) Applicant: Samsung Electronics Co., Ltd., Suwon-si (KR)

(72) Inventor: Jinmo YANG, Suwon-si (KR)

(21) Appl. No.: 19/461,110

(22) Filed: Jan. 27, 2026

Related U.S. Application Data
(63) Continuation of application No. PCT/KR2026/001424, filed on Jan. 23, 2026.

(30) Foreign Application Priority Data
Apr. 17, 2025 (KR) 10-2025-0050535
May 7, 2025 (KR) 10-2025-0059402
May 12, 2025 (KR) 10-2025-0061545

(51) Int. Cl. G06F 21/44

(52) U.S. Cl. CPC G06F 21/44

(57) ABSTRACT

An electronic device is provided. The electronic device includes memory, including one or more storage media, storing instructions, and at least one processor, including processing circuitry, communicatively coupled to the memory, wherein the instructions, when executed by the at least one processor individually or collectively, cause the electronic device to identify an event for verification of first security data written to a first storage area, read, using the kernel, information representing an address of the first storage area to which the first security data is written and second security data, from a second storage area, and read the first security data from the first storage area using the kernel, compare the second security data and the first security data for the verification of the first security data, and based on identifying the first security data different from the second security data in accordance with comparison, provide a notification representing an abnormal state of the first security data.

### CROSS-REFERENCE TO RELATED APPLICATION(S)

This application is a continuation application, claiming priority under 35 U.S.C. § 365(c), of an International application No. PCT/KR2026/001424, filed on Jan. 23, 2026, which is based on and claims the benefit of a Korean patent application number 10-2025-0050535, filed on Apr. 17, 2025, in the Ministry of Intellectual Property, of a Korean patent application number 10-2025-0059402, filed on May 7, 2025, in the Ministry of Intellectual Property, and of a Korean patent application number 10-2025-0061545, filed on May 12, 2025, in the Ministry of Intellectual Property, the disclosure of each of which is incorporated by reference herein in its entirety.

### BACKGROUND

### 1. Field

The disclosure relates to an electronic device, a method, and a non-transitory computer readable storage medium for identifying the integrity of stored data.

### 2. Description of Related Art

An electronic device may execute a user program using a user mode. The electronic device may execute a kernel function using a kernel mode. The electronic device may enter the kernel mode in response to a system call invoked from the user mode. The electronic device may execute a process in the kernel in response to an event that invokes the process in the kernel.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device, a method, and a non-transitory computer readable storage medium for identifying the integrity of stored data.

Additional aspects will be set forth in part in the description which follows and, in part, will be apparent from the description, or may be learned by practice of the presented embodiments.

In accordance with an aspect of the disclosure, an electronic device is provided. The electronic device includes memory, including one or more storage media, storing instructions, and at least one processor, including processing circuitry, communicatively coupled to the memory, wherein the instructions, when executed by the at least one processor individually or collectively, cause the electronic device to identify an event for verification of first security data written to a first storage area, wherein the first storage area is accessible by a kernel for reading and writing, based on the event, read, using the kernel, information representing an address of the first storage area to which the first security data is written and second security data which is reference data for verifying the first security data, from a second storage area, wherein the second storage area is accessible by the kernel for reading, and inaccessible by the kernel for writing, read, based on the address represented by the information, the first security data from the first storage area using the kernel, compare the second security data and the first security data for the verification of the first security data, and based on identifying the first security data different from the second security data in accordance with comparison, provide a notification representing an abnormal state of the first security data.

In accordance with another aspect of the disclosure, an electronic device is provided. The electronic device includes memory, including one or more storage media, storing instructions, and at least one processor, including processing circuitry, communicatively coupled to the memory, wherein the instructions, when executed by the at least one processor individually or collectively, cause the electronic device to identify an event for writing security data, based on the event, write the security data to a first storage area accessible by a kernel for reading and writing, using the kernel, identify, using the kernel, information representing an address of the first storage area to which the security data is written, and write the security data and the information to a second storage area which is accessible by the kernel for reading and inaccessible by the kernel for writing, using security software capable of accessing the second storage area for reading and writing, to verify the security data written to the first storage area.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include identifying an event for verification of first security data written to a first storage area, wherein the first storage area is accessible by a kernel for reading and writing, based on the event, reading, using the kernel, information representing an address of the first storage area to which the first security data is written and second security data which is reference data for verifying the first security data, from a second storage area, wherein the second storage area is accessible by the kernel for reading, and inaccessible by the kernel for writing, reading, based on the address represented by the information, the first security data from the first storage area using the kernel, comparing the second security data and the first security data for the verification of the first security data, and, based on identifying the first security data different from the second security data in accordance with the comparison, providing a notification representing an abnormal state of the first security data.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include identifying an event for writing security data, based on the event, writing the security data to a first storage area accessible by a kernel for reading and writing, using the kernel, identifying, using the kernel, information representing an address of the first storage area to which the security data is written, writing the security data and the information to a second storage area which is accessible by the kernel for reading and inaccessible by the kernel for writing, using security software capable of accessing the second storage area for reading, and writing, to verify the security data written to the first storage area.

In accordance with another aspect of the disclosure, a method performed by an electronic device is provided. The method includes identifying an event for verification of first security data written to a first storage area, wherein the first storage area is accessible by a kernel for reading and writing, reading, based on the event, using the kernel, information representing an address of the first storage area to which the first security data is written and second security data which is reference data for verifying the first security data, from a second storage area, wherein the second storage area is accessible by the kernel for reading, and inaccessible by the kernel for writing, reading, based on the address represented by the information, the first security data from the first storage area using the kernel, comparing the second security data and the first security data for the verification of the first security data, and providing a notification representing an abnormal state of the first security data, based on identifying the first security data different from the second security data in accordance with the comparison.

In accordance with another aspect of the disclosure, a method performed by an electronic device is provided. The method includes identifying an event for writing security data, writing, based on the event, the security data to a first storage area accessible by a kernel for reading and writing, using the kernel, identifying, using the kernel, information representing an address of the first storage area to which the security data is written, writing the security data and the information to a second storage area which is accessible by the kernel for reading and inaccessible by the kernel for writing, using security software capable of accessing the second storage area for reading, and writing, to verify the security data written to the first storage area.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a method for identifying integrity of first security data according to an embodiment of the disclosure;

FIG. 2 is a schematic diagram of an electronic device according to an embodiment of the disclosure;

FIG. 3 is a flowchart illustrating an operation of verifying first security data according to an embodiment of the disclosure;

FIG. 4 illustrates a method for allocating memory page inaccessible by a kernel for writing, using a hypervisor according to an embodiment of the disclosure;

FIG. 5 illustrates a flowchart of an operation of writing information for identifying integrity of security data according to an embodiment of the disclosure;

FIG. 6 illustrates an event for writing security data according to an embodiment of the disclosure;

FIG. 7 is a flowchart illustrating an operation for identifying an abnormal state of first security data according to an embodiment of the disclosure;

FIG. 8 is a flowchart illustrating an operation of identifying integrity of security data, based on a system call according to an embodiment of the disclosure;

FIG. 9 is a flowchart illustrating an operation of identifying integrity of security data, based on an event requesting a process in a kernel according to an embodiment of the disclosure;

FIG. 10 illustrates a visual object displayed to represent an abnormal state of first security data according to an embodiment of the disclosure; and

FIG. 11 is a block diagram of an electronic device in a network environment according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

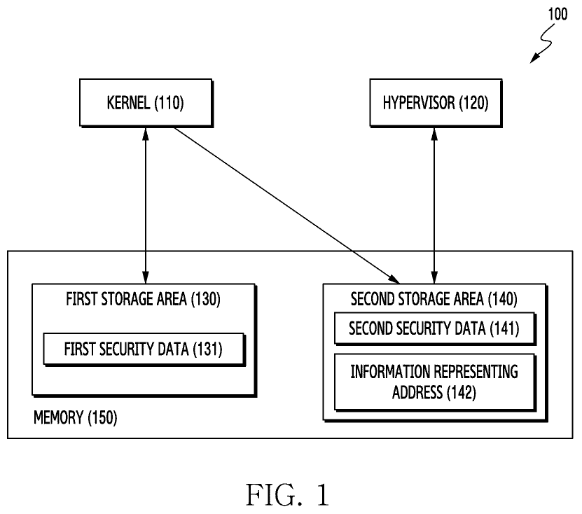

FIG. 1 illustrates a method for identifying integrity of first security data according to an embodiment of the disclosure.

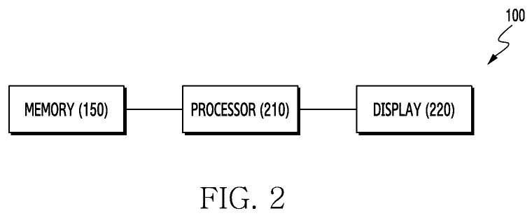

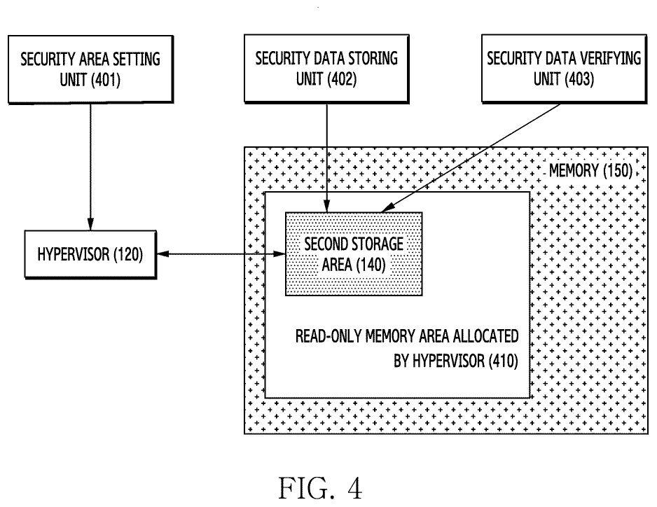

Referring to FIG. 1, memory 150 of an electronic device 100 may include a first storage area 130 accessible by a kernel 110 for reading and writing, and a second storage area 140 accessible by the kernel for reading and inaccessible by the kernel for writing. A hypervisor 120 may be accessible to the second storage area 140 for reading and writing. The hypervisor 120 may have higher authority than the kernel 110. For example, at least one processor (e.g., at least one processor 210 of FIG. 2) of the electronic device 100 may allocate a storage area accessible by the kernel 110 using the hypervisor 120. As an example, the at least one processor may write security data to the second storage area, which is inaccessible by the kernel 110 for writing, using the hypervisor 120. As an example, the at least one processor may allocate the first storage area 130 and the second storage area 140 using the hypervisor 120. A method for allocating the second storage area 140 using the hypervisor 120 will be described later with reference to FIG. 4.

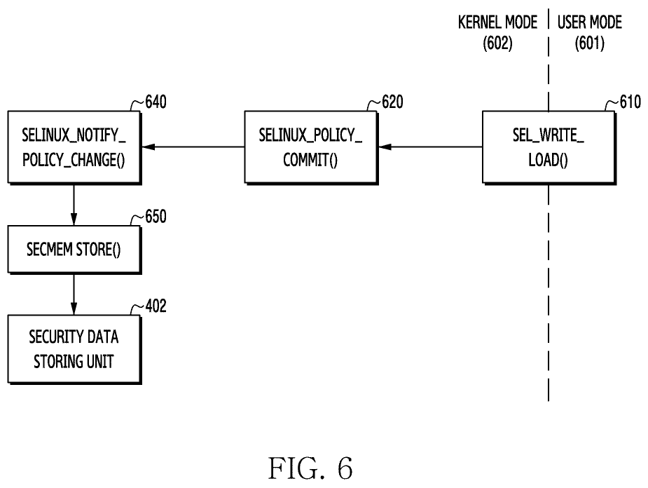

For example, the at least one processor may identify an event for writing first security data 131. The at least one processor may write the first security data 131 to the first storage area using the kernel, based on the event. The at least one processor may identify information representing an address of the first storage area 130 to which the first security data 131 is written. The event for writing the first security data 131 will be described later with reference to FIG. 6.

For example, the first security data 131 may include policy information. The policy information may be described as a rule defining how a subject may access an object in a system. As an example, the policy information may include information related to security-enhanced Linux (SELinux). SELinux may be described as technology related to security and control of a Linux system.

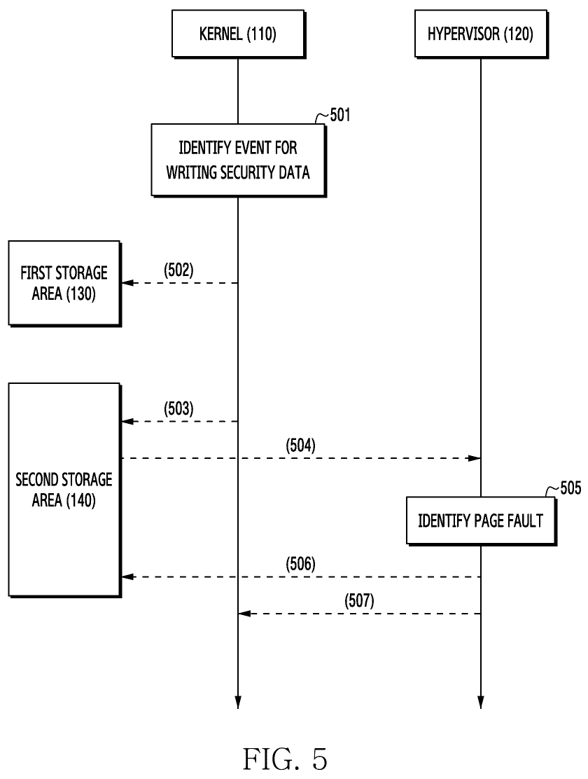

For example, the at least one processor may write, using the hypervisor 120, to the second storage area 140, second security data 141 corresponding to the first security data 131 and information 142 representing the address of the first storage area 130 to which the first security data 131 is written. For example, the information 142 representing the address may include information on a starting address of the first security data 131 stored in the first storage area 130 and information on a size of the first security data 131. As an example, the information on the starting address of the first security data 131 stored in the first storage area 130 may be expressed as “0xffff8812340000”. As an example, the information on the size of the first security data 131 having a size of 8 bytes may be expressed as “0x08”. The operation of writing to the second storage area 140 using the hypervisor 120 will be described later with reference to FIG. 5.

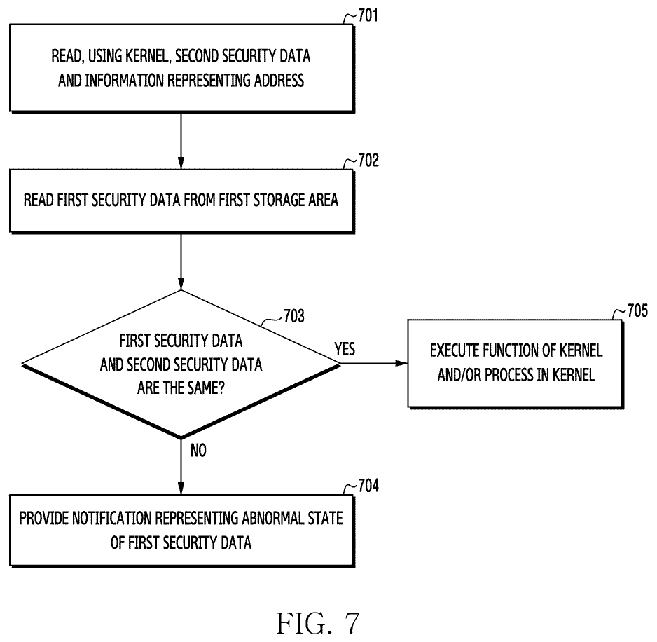

For example, the at least one processor may identify an event for verification of the first security data 131. The at least one processor may read, using the kernel 110, the second security data 141 and the information 142 representing the address of the first storage area 130 to which the first security data 131 is written, from the second storage area 140, based on the event for the verification. For example, the information 142 representing the address may include the information on the starting address of the first security data 131 stored in the first storage area 130 and the information on the size of the first security data 131. The at least one processor may read the first security data 131 from the first storage area 130 using the kernel 110, based on the address represented by the information 142 representing the address. The at least one processor may identify integrity of the first security data 131 by comparing the first security data 131 and the second security data 141. A method for identifying integrity of the first security data 131 will be described later with reference to FIGS. 7 to 9.

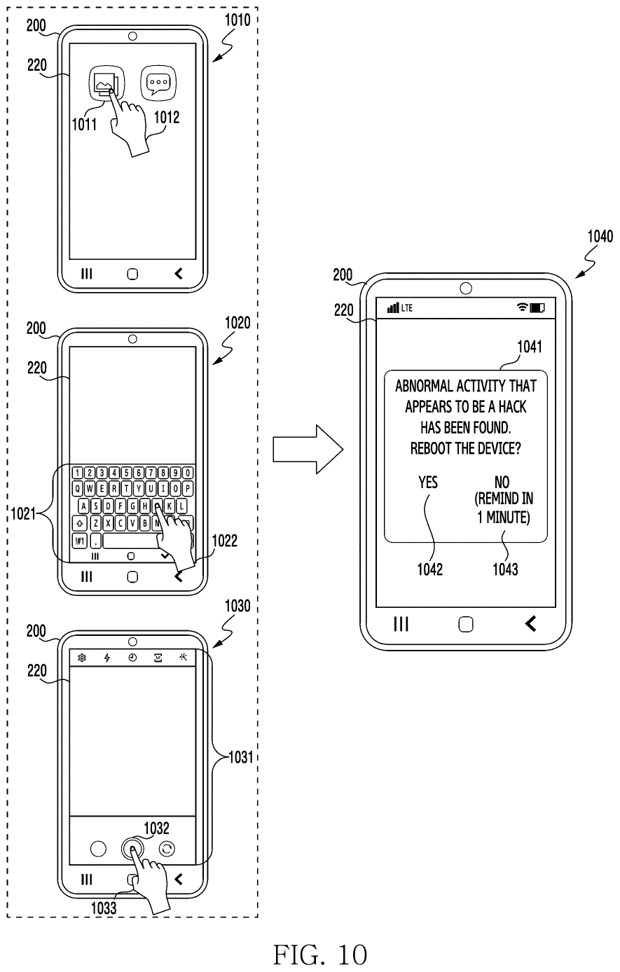

For example, the at least one processor may identify the first security data 131 different from the second security data 141. The at least one processor may provide a notification representing an abnormal state of the first security data 131, based on the identification. A method for providing the notification representing the abnormal state of the first security data 131 will be described later with reference to FIG. 10.

FIG. 2 is a schematic diagram of an electronic device according to an embodiment of the disclosure.

Referring to FIG. 2, an electronic device 100 may include at least one processor 210, a display 220, and memory 150. Some components of the electronic device 100 illustrated in FIG. 2 (e.g., the at least one processor 210, the display 220, and the memory 150) may be omitted from the electronic device 100. For example, the display 220 may be omitted from the electronic device 100.

For example, the at least one processor 210 may be operatively (or operably) coupled with or connected with the display 220 and/or the memory 150. The at least one processor 210 being operatively coupled with or connected with the display 220 and/or the memory 150 may mean that the at least one processor 210 may control the display 220 and/or the memory 150. For example, the display 220 and/or the memory 150 may be controlled by the at least one processor 210.

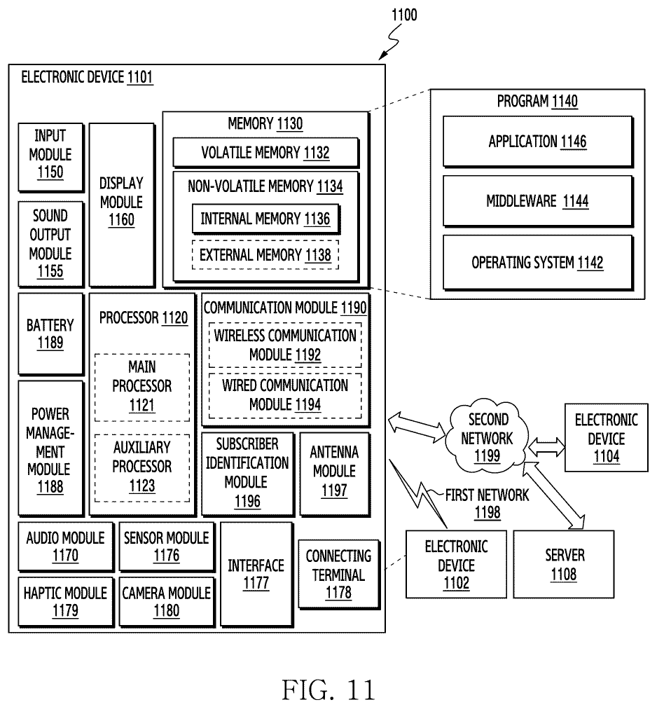

For example, the at least one processor 210 may include at least a portion of a processor 1120 of FIG. 11 or may correspond to at least a portion of the processor 1120. For example, the at least one processor 210 may include one or more processors including an application processor (AP) and/or a communication processor (CP). For example, the at least one processor 210 may be implemented as a single chip, such as a system on chip (SoC), or may be implemented as a plurality of chips. For example, the at least one processor 210 may be implemented as a single integrated circuitry. For example, the at least one processor 210 may include a first integrated circuitry and a second integrated circuitry. For example, the at least one processor 210 may be arranged in a distributed manner in the electronic device 100. For example, a portion of the at least one processor 210 may be physically spaced apart from another portion of the at least one processor 210. As a non-limiting example, the other portion of the at least one processor 210 may be spaced apart from the portion of the at least one processor 210, but the other portion of the at least one processor 210 may be connected to the portion of the at least one processor 210 via interface circuitry.

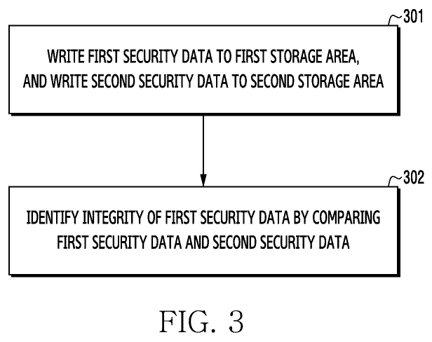

The at least one processor 210 may execute instructions stored in the memory 150 to cause the electronic device 100 to perform operations that will be described with reference to FIGS. 3 to 10.

The display 220 may include at least a portion of a display module 1160 of FIG. 11 or may correspond to at least a portion of the display module 1160. The display 220 of the electronic device 100 may output visualized information (e.g., a screen) to a user. For example, the display 220 may output visualized information in accordance with control of a controller, such as a graphics processing unit (GPU) (e.g., included in the at least one processor 210). The display 220 may include a liquid crystal display (LCD) display, a plasma display panel (PDP), and/or a light emitting diode (LED) display. The LED display may include an organic LED (OLED) display. The display 220 may be at least partially curved or deformable. The deformable display 220 may include a flexible display.

The memory 150 of the electronic device 100 may include circuitry and/or a storage medium for storing data and/or instructions input to and/or output from the at least one processor 210. The memory 150 may include, for example, volatile memory, such as random-access memory (RAM) and/or non-volatile memory, such as read-only memory (ROM). The non-volatile memory may be referred to as storage. The volatile memory may include, for example, at least one of dynamic RAM (DRAM), static RAM (SRAM), cache RAM, and pseudo SRAM (PSRAM). The non-volatile memory may include, for example, at least one of programmable ROM (PROM), erasable PROM (EPROM), electrically erasable PROM (EEPROM), flash memory, hard disk, compact disc, solid state drive (SSD), and embedded multi media-card (eMMC).

The memory 150 may include at least a portion of memory 1130 of FIG. 11 or may correspond to at least a portion of the memory 1130. For example, the memory 150 may be implemented as a single chip, or may be implemented as a plurality of chips. For example, the memory 150 may be implemented as one integrated circuitry, or may be implemented as a plurality of integrated circuitry (e.g., including a first integrated circuitry and a second integrated circuitry). For example, the memory 150 may be arranged in a distributed manner in the electronic device 100.

The memory 150 may store one or more programs configured to be executed individually or collectively by the at least one processor 210. The one or more programs may include at least a portion of instructions which, when executed individually or collectively by the at least one processor 210, cause the electronic device 100 to perform the operations that will be described with reference to FIGS. 3 to 10.

FIG. 3 is a flowchart illustrating an operation of verifying first security data according to an embodiment of the disclosure. In the following embodiment of the disclosure, each of operations may be performed sequentially, but is not necessarily performed sequentially. For example, an order of each of the operations may be changed, and at least two operations may be performed in parallel.

Referring to FIG. 3, in operation 301, the at least one processor 210 may write first security data 131 to a first storage area 130. The at least one processor 210 may write second security data 141 to a second storage area 140. The first storage area may be accessible by a kernel 110 for reading and writing. The second storage area may be accessible by the kernel for reading, and inaccessible by the kernel for writing. For example, the second storage area may be accessible by security software for reading and writing. As an example, the second security data may be described as reference data for verifying the first security data.

For example, the first storage area 130 and the second storage area 140 may be distinguished. As an example, the first storage area 130 may be included in memory area accessible by the kernel 110 for reading and writing. As an example, the second storage area 140 may be included in memory area inaccessible by the kernel 110 for writing. As an example, the second storage area 140 may be included in memory area accessible by a hypervisor 120 for reading and writing.

For example, the security software may have higher authority than the kernel. The security software may be referred to as a hypervisor and/or a secure monitor. For example, the secure monitor may be described as security software having higher authority than the hypervisor. In a case in which the security software is the secure monitor, the at least one processor 210 may use a trust zone via the secure monitor. For example, the at least one processor 210 may distinguish a normal world and a secure world by using the trust zone. The first storage area may correspond to the normal world. The second storage area may correspond to the secure world. For example, the normal world and the secure world may be separated at a hardware level. For example, code executed in the secure world may be inaccessible from the normal world. For example, the at least one processor 210 may switch from the secure world to the normal world using the secure monitor. The at least one processor 210 may switch from the normal world to the secure world using the secure monitor.

The term “hypervisor” used in the disclosure may represent the security software. For example, the hypervisor may be described as a software component having higher authority than that of the kernel and used for security of the electronic device 100.

For example, the at least one processor 210 may write the first security data to the first storage area using the kernel. For example, the at least one processor 210 may write, using the hypervisor, the second security data corresponding to the first security data and information representing an address of the first storage area to which the first security data is written, to the second storage area. For example, information 142 representing the address may include information on a starting address of the first security data 131 stored in the first storage area 130 and information on a size of the first security data 131. As an example, the at least one processor 210 may attempt to write, using the kernel, the second security data corresponding to the first security data and the information representing the address of the first storage area to which the first security data is written, to the second storage area before using the hypervisor. A method of attempting to write to the second storage area using the kernel will be described later with reference to FIG. 5.

In operation 302, the at least one processor 210 may identify integrity of the first security data by comparing the first security data and the second security data using the kernel.

For example, the at least one processor 210 may read, using the kernel, the second security data and the information representing the address of the first storage area to which the first security data is written, from the second storage area. The at least one processor 210 may read the first security data from the first storage area, using the kernel, based on the address represented by the information.

For example, the at least one processor 210 may compare the second security data and the first security data to verify the first security data. For example, the at least one processor 210 may identify integrity of the first security data using the kernel. A method of identifying integrity of the first security data by comparing the second security data and the first security data may correspond to the method described in FIG. 7.

As described above, according to the operation described in FIG. 3, the at least one processor 210 may write, using security software (e.g., the hypervisor 120 of FIG. 1), the second security data, which is reference data for verifying the first security data, to the second storage area. The at least one processor 210 may identify integrity of the first security data by comparing the first security data and the second security data using the kernel.

FIG. 4 illustrates a method for allocating memory page inaccessible by a kernel for writing, using a hypervisor according to an embodiment of the disclosure.

Referring to FIG. 4, memory 150 may include instructions for a security area setting unit 401, a security data storing unit 402, and a security data verifying unit 403. For example, the security area setting unit 401 may be referred to as SecMonInit. The security data storing unit 402 may be referred to as SecMonStore. The security data verifying unit 403 may be referred to as SecMonWatch.

For example, at least one processor 210 may allocate a second storage area 140 via a hypervisor 120, using the security area setting unit 401. The at least one processor 210 may cause the hypervisor 120 to allocate the second storage area 140, using the security area setting unit 401. For example, the second storage area 140 may be set to be accessible by the hypervisor 120 for reading and writing. The second storage area 140 may be set to be accessible by a kernel 110 for reading, and inaccessible by the kernel 110 for writing. For example, the second storage area 140 may be memory page. For example, the at least one processor 210 may set an attribute related to access of the second storage area 140, which is the memory page. For example, the at least one processor 210 may allocate the second storage area 140 having a read-only attribute, using the hypervisor 120.

For example, the at least one processor 210 may identify memory page operating in a kernel mode. The memory page operating in the kernel mode may be accessible by the kernel for reading and writing. The at least one processor 210 may change the memory page to read-only memory page, using the hypervisor 120. The read-only memory page may correspond to the second storage area 140.

For example, the second storage area 140 may be included in read-only memory area 410 allocated by the hypervisor 120. For example, the read-only memory area 410 allocated by the hypervisor 120 may be included in the memory 150. As an example, the first storage area 130 of FIG. 1 may be distinguished from the read-only memory area 410 allocated by the hypervisor.

For example, the at least one processor 210 may identify information representing an address of the second storage area 140, using the security area setting unit 401. As an example, the at least one processor 210 may provide the information representing the address of the second storage area 140 to the security data storing unit 402 and the security data verifying unit 403, using the security area setting unit 401.

For example, the at least one processor 210 may identify an event for writing first security data 131, using the security data storing unit 402. For example, the at least one processor 210 may write the first security data 131 to the first storage area 130 via the kernel, using the security data storing unit 402. The at least one processor 210 may write second security data 141 and information 142 representing an address of the first storage area 130 to which the first security data 131 is written, to the second storage area 140 via the hypervisor 120, using the security data storing unit 402.

For example, the at least one processor 210 may identify an event for verification of the first security data 131, using the security data verifying unit 403. For example, the at least one processor 210 may read the second security data 141 and the information 142 representing the address of the first storage area 130 to which the first security data 131 is written, written to the second storage area 140, using the security data verifying unit 403. The at least one processor 210 may read the first security data 131 written to the first storage area 130, based on the address represented by the information 142 representing the address, using the security data verifying unit 403. The at least one processor 210 may compare the first security data 131 and the second security data 141, using the security data verifying unit 403. The at least one processor 210 may identify integrity of the first security data 131, based on the comparison, using the security data verifying unit 403.

FIG. 5 illustrates a flowchart of an operation of writing information for identifying integrity of security data according to an embodiment of the disclosure. In the following embodiment of the disclosure, each of operations may be performed sequentially, but is not necessarily performed sequentially. For example, an order of each of the operations may be changed, and at least two operations may be performed in parallel.

Referring to FIG. 5, in operation 501, at least one processor 210 may identify an event for writing first security data, using a kernel 110. For example, first security data 131 may include information related to a component (e.g., unified extensible firmware interface (UEFI) or an operating system (OS) bootloader) loaded during booting and/or policy information. The policy information may be described as a rule defining how a subject may access an object in a system. As an example, the policy information may include information related to SELinux. SELinux may be described as technology related to security and control of a Linux system.

For example, the event for writing the first security data may occur during booting of an electronic device 100, immediately before booting of the electronic device 100, or immediately after completion of booting of the electronic device 100. For example, the event for writing the first security data may occur after booting. An embodiment in which the event for writing the first security data occurs in accordance with setting policy information related to SELinux immediately after booting will be described later with reference to FIG. 6.

In operation 502, the at least one processor 210 may write the first security data to a first storage area 130, using the kernel 110. The first storage area may be accessible by the kernel for reading and writing. For example, the first storage area 130 may be included in memory 150. As an example, the first storage area 130 may be allocated by a hypervisor 120 of the at least one processor 210.

In operation 503, the at least one processor 210, after writing the first security data 131 to the first storage area 130 using the kernel 110, may attempt to write, using the kernel 110, second security data 141 and information 142 representing an address of the first storage area 130 to which the first security data 131 is written, to a second storage area 140. For example, the information 142 representing the address of the first storage area 130 to which the first security data 131 is written may include information on a starting address of the first security data 131 and information on a size of the first security data 131.

For example, the first security data and the second security data may be expressed as “0xffff80abcd0000”. As an example, the information on the starting address may be expressed as “0xffff8812340000”. As an example, the information on the size of the first security data 131 having a size of 8 bytes may be expressed as “0x08”. As an example, the at least one processor 210 may write the information on the size of the first security data 131 to the second storage area 140, and based on writing the information on the size of the first security data 131 to the second storage area 140, may write the information on the starting address of the first security data 131 to the second storage area 140, and based on writing the information on the starting address of the first security data 131 to the second storage area 140, may write the second security data 141 to the second storage area 140. As an example, the at least one processor 210 may write “0x08ffff8812340000ffff80abcd0000” to the second storage area 140. The “0x” corresponding to the prefix of “0x08ffff8812340000ffff80abcd0000” may indicate that a portion of “0x08ffff8812340000ffff80abcd0000” following “0x” (e.g., “08ffff8812340000ffff80abcd0000”) is expressed in hexadecimal.

For example, since the second storage area 140 is inaccessible by the kernel 110 for writing, the at least one processor 210 may fail to write the second security data 141 and the information 142 representing the address to the second storage area 140 using the kernel 110, in accordance with the attempt.

In operation 504, based on failing to write the second security data 141 and the information 142 representing the address to the second storage area 140 in accordance with the attempt in operation 503, a page fault may be generated. For example, the at least one processor 210 may generate the page fault using memory management unit (MMU) (e.g., including circuitry). The MMU may be included in a central processing unit (CPU) (e.g., including processing circuitry). For example, the MMU may be described as a hardware module responsible for controlling memory access rights. For example, the page fault may be trapped by the hypervisor 120. For example, the at least one processor 210 may identify the page fault using the hypervisor 120.

For example, the at least one processor 210 may request the hypervisor 120 to write the second security data 141 and the information 142 representing the address to the second storage area 140 using the hypervisor 120, based on failing to write the second security data 141 and the information 142 representing the address to the second storage area 140.

For example, since the page fault has occurred, a control flow may be transferred, changed, switched, or adjusted from the kernel 110 to the hypervisor 120. For example, the control flow may be described as an execution order of code or a system. As an example, the at least one processor 210 may transfer the control flow from the kernel 110 to the hypervisor 120, based on the occurrence of the page fault.

For example, the at least one processor 210 may invoke a hypervisor call (HVC), based on failing to write, using the kernel 110, the second security data 141 and the information 142 representing the address of the first storage area 130 to which the first security data 131 is written, to the second storage area 140. For example, the at least one processor 210 may request the hypervisor 120 to write the second security data 141 and the information 142 representing the address of the first storage area 130 to which the first security data 131 is written, to the second storage area 140 by invoking the HVC.

In operation 505, the at least one processor 210 may identify the page fault using the hypervisor 120. For example, the page fault may be trapped by the hypervisor 120. For example, the at least one processor 210 may identify a cause and/or a type of the page fault using the hypervisor 120. For example, the at least one processor 210 may identify an address at which the page fault occurred using the hypervisor 120.

In operation 506, the at least one processor 210 may write the second security data 141 and the information 142 representing the address of the first storage area 130 to which the first security data 131 is written, to the second storage area 140 using the hypervisor 120, based on identifying the cause of the page fault, the type of the page fault, and/or the address at which the page fault occurred. Since the hypervisor 120 is accessible to the second storage area 140 for reading and writing, the hypervisor 120 may write the second security data 141 and the information 142 to the second storage area without occurrence of the page fault.

According to an embodiment of the disclosure, the at least one processor 210 may write the second security data 141 and the information 142 representing the address of the first storage area 130 to which the first security data 131 is written, to the second storage area using the hypervisor 120, based on refraining from writing to the second storage area 140 using the kernel 110 after the first security data 131 is written to the first storage area 130. For example, since the attempt to write the second security data and the information 142 representing the address of the first storage area 130 to which the first security data 131 is written, to the second storage area using the kernel 110, was not made, the operation 503, the operation 504, and/or the operation 505 may be omitted. For example, the at least one processor 210 may perform the operation 506 without performing the operation 503, the operation 504, and the operation 505, based on performing the operation 502.

In operation 507, the at least one processor 210 may transfer the control flow from the hypervisor to the kernel. For example, after the control flow is transferred from the hypervisor to the kernel, the at least one processor 210 may execute code and/or a process in the kernel 110 that was being executed immediately before the event for writing security data occurred.

As described above, according to the operation described in FIG. 5, the at least one processor 210 may write the second security data 141 and the information 142 representing the address of the first storage area 130 to which the first security data 131 is written, to the second storage area 140. According to an embodiment to be described, a security system including the kernel and the hypervisor having higher authority than the kernel may be maintained.

FIG. 6 illustrates an event for writing security data according to an embodiment of the disclosure.

Referring to FIG. 6, use of a sel_write_load function 610, use of a selinux_policy_commit function 620, use of a selinux_notify_policy_change function 640, and use of a secmem_store function 650 may correspond to an event for writing first security data 131. For example, at least one processor 210 may write a new SELinux policy in a user mode 601, using the sel_write_load function 610. For example, Security-Enhanced Linux (SELinux) may be described as a security module of a Linux kernel for applying a security policy to a Linux system. For example, the SELinux policy may include information related to mapping between a process in the kernel and an actual resource of the kernel. For example, the at least one processor 210 may transfer a control flow from the user mode 601 to a kernel mode 602, using the sel_write_load function 610. For example, the at least one processor 210 may identify validity of the new SELinux policy, using the selinux_policy_commit function 620. For example, the at least one processor 210 may apply the policy to the Linux system, based on the validity of the new SELinux policy, using the selinux_policy_commit function 620.

For example, the at least one processor 210 may provide information representing that the policy has changed to the inside of SELinux or another kernel component, using the selinux_notify_policy_change function 640. For example, the at least one processor 210 may identify an event for writing the first security data 131, using the function 640. For example, the at least one processor 210 may store data related to the SELinux security policy in security memory, using the secmem_store function 650. As an example, the security memory may include memory managed by a secure world in a trust zone and/or a hypervisor (e.g., the hypervisor 120 of FIG. 1).

For example, the at least one processor 210 may write the first security data 131 to a first storage area 130, using a security data storing unit 402, based on invocation of the function 650. The at least one processor 210 may write second security data 141 and information 142 representing an address of the first storage area 130 to which the first security data 131 is written, to a second storage area 140 using the security data storing unit 402, based on invocation of the function 650.

FIG. 7 is a flowchart illustrating an operation for identifying an abnormal state of first security data according to an embodiment of the disclosure. In the following embodiment of the disclosure, each of operations may be performed sequentially, but is not necessarily performed sequentially. For example, an order of each of the operations may be changed, and at least two operations may be performed in parallel.

Referring to FIG. 7, in operation 701, at least one processor 210 may read using a kernel 110, second security data 141 and information 142 representing an address of a first storage area 130 to which first security data 131 is written, from a second storage area 140. For example, the at least one processor 210 may read the second security data 141 and the information 142 representing the address of the first storage area 130 to which the first security data 131 is written, from the second storage area 140, based on identifying an event for verification of the first security data 131. The event for the verification of the first security data 131 will be described later with reference to FIG. 10.

In operation 702, the at least one processor 210 may read the first security data 131 written to the first storage area 130, using the address represented by the information 142 representing the address. For example, the information 142 representing the address may include information on a starting address of the first security data 131 and information on a size of the first security data 131. As an example, the at least one processor 210 may read the first security data 131 by reading the first storage area 130 by the size of the first security data 131 from the starting address of the first security data 131.

In operation 703, the at least one processor 210 may identify whether the first security data 131 and the second security data 141 are the same. For example, the at least one processor 210 may verify the first security data 131. For example, the kernel 110 and/or the first storage area 130 may be hacked. For example, as the kernel 110 and/or the first storage area 130 is hacked, the first security data 131 may be forged or tampered. For example, the at least one processor 210 may identify that the forged or tampered first security data is different from the second security data 141, based on the forged first security data. As an example, the at least one processor 210 may verify the first security data 131 by identifying integrity of the first security data 131. As an example, the at least one processor 210 may verify the first security data 131 by authenticating the first security data 131.

For example, the at least one processor 210 may identify that the first security data 131 and the second security data 141 are different. For example, the first security data 131 written to the first storage area 130 may be tampered. For example, the first security data 131 written to the first storage area 130 may be forged. As an example, the kernel 110 may be hacked (or cracked).

As an example, the first storage area 130 accessible by the kernel 110 for reading and writing may be hacked. As an example, the first storage area 130 may be hacked due to memory error (e.g., a stack overflow). As an example, when a malignant kernel module (or loadable kernel module) and/or a rootkit is inserted into the kernel, the first storage area 130 may be hacked.

As an example, a system call table mapping a system call number and a function of the kernel 110 may be tampered. When the system call table is tampered, the first storage area 130 may be hacked.

As an example, when the first storage area 130 is hacked, the first security data 131 may be forged or tampered. The at least one processor 210 may identify the first security data 131 different from the second security data 141, based on the forged or tampered first security data 131.

As an example, the first storage area 130 accessible by the kernel 110 for reading and writing may be hacked. As an example, the first storage area 130 may be hacked due to memory error (e.g., a stack overflow). As an example, when a malignant kernel module (or loadable kernel module) and/or a rootkit is inserted into the kernel, the first storage area 130 may be hacked.

As an example, a system call table mapping a system call number and a function of the kernel 110 may be tampered. When the system call table is tampered, the first storage area 130 may be hacked.

In operation 704, the at least one processor 210 may provide a notification representing an abnormal state of the first security data 131, based on identifying the first security data 131 different from the second security data 141. For example, the at least one processor 210 may provide the notification representing the abnormal state of the first security data 131 by providing a notification representing that an electronic device 100 has been hacked. For example, the at least one processor 210 may provide the notification representing the abnormal state of the first security data 131 by providing a notification representing that the security data has been changed by unauthorized access.

For example, the at least one processor 210 may provide the notification representing the abnormal state of the first security data 131 by displaying a visual object representing the abnormal state of the first security data 131 via a display 220. A method for displaying the visual object will be described later with reference to FIG. 10.

For example, the at least one processor 210 may identify the first security data different from the second security data 141, based on the forged first security data. For example, the at least one processor 210 may erase the first security data 131 written to the first storage area 130, based on identifying the first security data 131 different from the second security data 141. For example, the at least one processor 210 may initialize the first security data 131, based on identifying the first security data 131 different from the second security data 141. The at least one processor 210 may write third security data corresponding to the second security data 141 to the first storage area, using the kernel 110. The at least one processor 210 may identify information representing an address of the first storage area to which the third security data is written, using the kernel 110. The at least one processor 210 may write the information representing the address of the first storage area to which the third security data is written, to the second storage area 140, in conjunction with the second security data 141. As an example, the at least one processor 210 may update the security data and the information representing the address written to the second storage area, based on writing the third security data to the first storage area.

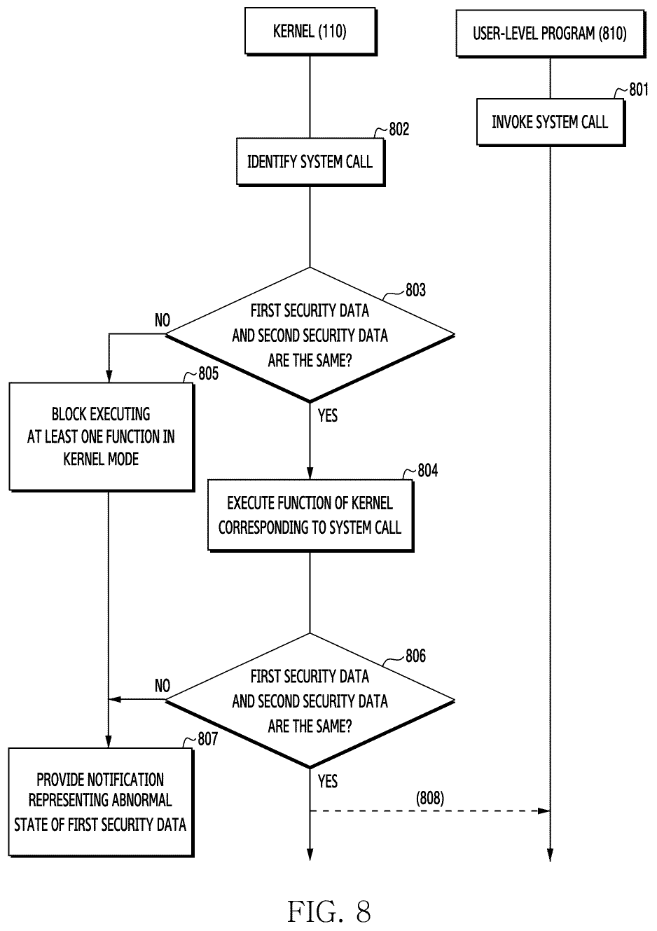

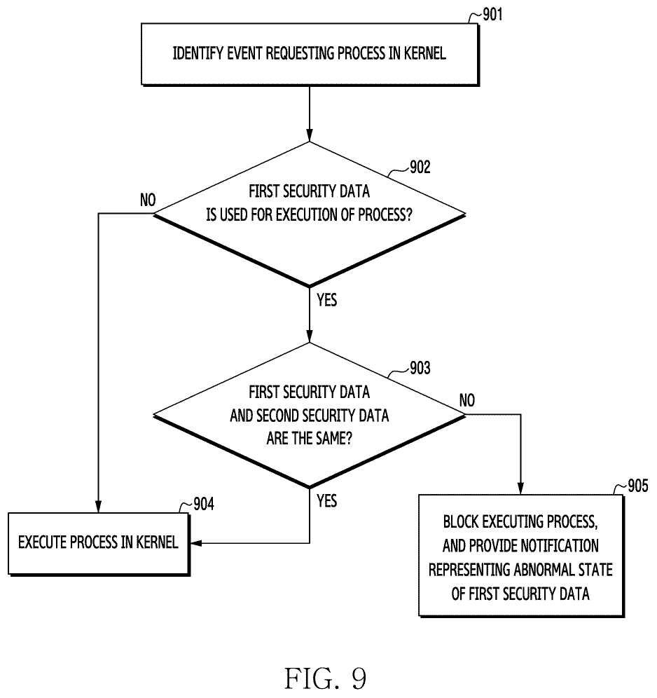

In operation 705, the at least one processor 210 may execute a function of the kernel 110 and/or a process in the kernel 110, based on identifying the first security data 131 corresponding to the second security data 141. For example, the function of the kernel 110 may be executed based on a system call described in FIG. 8. A method for executing the function of the kernel 110 based on a system call invoked from a user-level program for requesting the function of the kernel 110 will be described later with reference to FIG. 8. For example, the process in the kernel 110 may be executed based on an event requesting the process in the kernel 110 described in FIG. 9. A method for executing the process in the kernel 110 will be described later with reference to FIG. 9.

As described above, according to the operation described in FIG. 7, the at least one processor 210 may enhance a security level of the electronic device 100 by verifying the first security data 131 before executing a function of the kernel and/or a process in the kernel. The at least one processor 210 may verify the first security data 131 more quickly by comparing the first security data 131 and the second security data 141 using the kernel 110.

FIG. 8 is a flowchart illustrating an operation of identifying integrity of security data, based on a system call according to an embodiment of the disclosure. In the following embodiment of the disclosure, each of operations may be performed sequentially, but is not necessarily performed sequentially. For example, an order of each of the operations may be changed, and at least two operations may be performed in parallel.

Referring to FIG. 8, in operation 801, at least one processor 210 may invoke a system call, which is an event for verification of first security data 131. For example, the at least one processor 210 may invoke the system call by a user-level program 810. For example, the system call may be invoked to request a function of a kernel 110. For example, the at least one processor 210 may enter a kernel mode, based on the system call. For example, entering the kernel mode from the user-level program 810 may be described as a system call entry.

According to an embodiment of the disclosure, the kernel may be described as software that performs a core function of an operating system. The kernel mode may be described as an operation authority state of a CPU. As an example, the at least one processor 210 may manage resources and process interrupts, using the kernel. The at least one processor 210 may enter the kernel mode from a user mode in response to the system call.

In operation 802, the at least one processor 210 may identify the system call invoked from the user-level program 810, using the kernel 110. For example, the at least one processor 210 may identify the system call number. For example, the at least one processor 210 may identify a function of the kernel 110 corresponding to the system call number. For example, the at least one processor 210 may transfer a control flow from the user-level program 810 to the kernel 110, in response to the system call.

In operation 803, the at least one processor 210 may identify whether the first security data 131 and second security data 141 are the same. According to an embodiment of the disclosure, the at least one processor 210 may identify whether the first security data 131 and the second security data 141 are the same, based on the number of times system calls are invoked. For example, the at least one processor 210 may identify whether the first security data 131 and the second security data 141 are the same, based on system calls being invoked a reference number of times from the user-level program 810. As an example, the at least one processor 210 may identify whether the first security data 131 and the second security data 141 are the same whenever system calls are invoked the reference number of times from the user-level program 810. The at least one processor 210 may identify whether the first security data 131 and the second security data 141 are the same, in accordance with a reference number of system calls.

For example, the at least one processor 210 may identify whether the first security data 131 and the second security data 141 are the same, based on identifying that the number of times the system call are invoked from the user-level program 810 exceeds a reference number (e.g., 9 times). As an example, the at least one processor 210 may identify whether the first security data 131 and the second security data 141 are the same, in response to the 10th system call, the 20th system call, and the 30th system call, based on the system call being invoked 35 times.

For example, the at least one processor 210 may read the second security data 141 and information 142 representing an address of a first storage area 130 to which the first security data 131 is written, from a second storage area 140. The at least one processor 210 may read the first security data 131 from the first storage area 130, using the address represented by the information 142. For example, the at least one processor 210 may identify the first security data 131 corresponding to the second security data 141. For example, the at least one processor 210 may identify the first security data 131 different from the second security data 141. The operation 803 may correspond to the operation 703 described in FIG. 7.

In operation 804, the at least one processor 210 may execute a function of the kernel 110 corresponding to the system call invoked from the user-level program 810. For example, the at least one processor 210 may identify the system call number and the system call table. For example, the at least one processor 210 may identify a function in the kernel corresponding to the system call number, using the system call table. For example, the system call table may be described as a table mapping the system call number and the function of the kernel.

In operation 805, the at least one processor 210 may block executing at least one function in the kernel mode, based on identifying the first security data 131 different from the second security data 141. For example, the at least one processor 210 may perform a reboot of an electronic device 100, based on identifying the first security data 131 different from the second security data 141. For example, the at least one processor 210 may initialize the first security data by performing the reboot of the electronic device 100.

In operation 806, the at least one processor 210 may identify whether the first security data 131 and the second security data 141 are the same before exiting the kernel mode, after executing the function of the kernel corresponding to the system call. For example, the at least one processor 210 may read the second security data 141 and the information 142 representing the address of the first storage area 130 to which the first security data 131 is written, from the second storage area 140 before exiting the kernel mode. The at least one processor 210 may read the first security data 131 from the first storage area 130, using the address represented by the information 142. The at least one processor 210 may compare the first security data 131 and the second security data 141. The operation 806 may correspond to the operation 803.

In operation 807, the at least one processor 210 may provide a notification representing an abnormal state of the first security data 131, based on identifying the first security data 131 different from the second security data 141. The operation 807 may correspond to the operation 704 of FIG. 7.

For example, the at least one processor 210 may provide the notification representing the abnormal state of the first security data 131, based on blocking executing at least one function in the kernel mode. A method for providing the notification representing the abnormal state of the first security data 131 will be described later with reference to FIG. 10.

In operation 808, the at least one processor 210 may transfer a control flow from the kernel 110 to the user-level program 810 after identifying integrity of the first security data 131. For example, the control flow being transferred from the kernel 110 to the user-level program 810 may be described as a system call exit. For example, the at least one processor 210 may execute the user-level program 810 that was executed before the system call was invoked, in response to the control flow being transferred from the kernel 110 to the user-level program 810.

As described above, according to the operation described in FIG. 8, the at least one processor 210 may perform verification of the first security data 131 twice, based on the system call. The at least one processor 210 may identify integrity of the first security data 131, based on entering the kernel mode. The at least one processor 210 may enhance a security level of the electronic device 100 by verifying the first security data 131 based on the system call.

FIG. 9 is a flowchart illustrating an operation of identifying integrity of security data, based on an event requesting a process in a kernel according to an embodiment of the disclosure. In the following embodiment of the disclosure, each of operations may be performed sequentially, but is not necessarily performed sequentially. For example, an order of each of the operations may be changed, and at least two operations may be performed in parallel.

Referring to FIG. 9, in operation 901, at least one processor 210 may identify an event requesting a process in a kernel 110. The event requesting a process in the kernel 110 may include an interrupt generated in hardware and/or software. For example, the at least one processor 210 may cease an executing process in response to identifying the interrupt, and may process the interrupt using an interrupt handler (or an interrupt service routine). For example, the interrupt handler may be described as a function in the kernel for immediately responding to the interrupt. As an example, the interrupt generated in the hardware may include a keyboard input. As an example, the interrupt generated in the software may include an expiration event of a timer defined by the software.

In operation 902, the at least one processor 210 may identify whether first security data 131 is used for execution of the process in the kernel 110. For example, the at least one processor 210 may identify whether the first security data 131 is used for execution of the process in the kernel 110, based on kernel source code. As an example, the at least one processor 210 may identify whether the first security data 131 is used for execution of the process in the kernel 110 by analyzing the kernel source code. For example, the at least one processor 210 may identify whether the first security data 131 is used for execution of the process in the kernel 110 by generating an interrupt when accessing memory address in which the first security data 131 is stored, immediately before the first security data 131 is used. For example, the interrupt that occurs when accessing the memory address in which the first security data 131 is stored, immediately before the first security data 131 is used, may correspond to the event requesting the process in the kernel 110 described in the operation 901.

In operation 903, the at least one processor 210 may identify whether the first security data 131 and second security data 141 are the same. For example, the at least one processor 210 may read the second security data 141 and information 142 representing an address of a first storage area 130 to which the first security data 131 is written, from a second storage area 140. The at least one processor 210 may read the first security data 131 from the first storage area 130, using the address represented by the information 142. The at least one processor 210 may compare the first security data 131 and the second security data 141.

For example, the at least one processor 210 may identify that the second security data 141 is different from the first security data 131, based on the comparison. For example, the at least one processor 210 may identify that the second security data 141 is the same as the first security data 131, based on the comparison. The operation 903 may correspond to the operation 703 described in FIG. 7.

In operation 904, the at least one processor 210 may execute the process in the kernel 110, based on identifying the first security data 131 corresponding to the second security data 141. For example, the at least one processor 210 may use the first security data 131 while executing the process in the kernel 110 based on the identification. The at least one processor 210 may execute the process in the kernel 110, using the first security data 131 having the same value as the second security data 141, which is reference data for verification of the first security data 131.

In operation 905, the at least one processor 210 may block executing the process in the kernel 110, based on identifying the first security data 131 different from the second security data 141. For example, the at least one processor 210 may execute a process that was executed before the event requesting the process in the kernel 110 occurred, based on the identification. The at least one processor 210 may provide a notification representing an abnormal state of the first security data 131, based on identifying the first security data 131 different from the second security data 141. The operation 905 may correspond to the operation 805 and/or the operation 807 described in FIG. 8.

As described above, according to the operation described in FIG. 9, the at least one processor 210 may identify integrity of the first security data 131, based on the event requesting the process in the kernel 110, independently of invocation of a system call. The at least one processor 210 may enhance a security level of an electronic device 100 by verifying the first security data 131 based on the event requesting the process in the kernel 110.

FIG. 10 illustrates a visual object displayed to represent an abnormal state of first security data according to an embodiment of the disclosure.

Referring to FIG. 10, at least one processor 210 may provide a notification representing an abnormal state of first security data 131, based on identifying an event for verification of the first security data 131 (e.g., a user input 1012 for application execution, a user input 1022 for keyboard input, or a user input 1033 for camera capture).

For example, the at least one processor 210 may enter a kernel mode 602 from a user mode 601, based on the event for the verification of the first security data 131. For example, a system call may be invoked from a user-level program 810, based on the event for the verification of the first security data 131. The at least one processor 210 may verify the first security data 131, based on entering the kernel mode or based on the system call. For example, the at least one processor 210 may provide a notification representing the abnormal state of the first security data 131, based on identifying the first security data 131 different from second security data 141.

For example, the at least one processor 210 may identify whether the first security data 131 and the second security data 141 are the same, based on the user input 1012 for application execution. For example, the user input 1012 may be described as a touch input on a user interface (UI) object 1011 displayed via a display. For example, the at least one processor 210 may change a state of an electronic device 100 from state 1010 to state 1040, based on identifying the first security data 131 different from the second security data 141.

For example, the at least one processor 210 may display an interface 1021 for keyboard input via the display. For example, the at least one processor 210 may identify whether the first security data 131 and the second security data 141 are the same, based on the user input 1022 for keyboard input. For example, the at least one processor 210 may change a state of the electronic device 100 from state 1020 to the state 1040, based on identifying the first security data 131 different from the second security data 141.

For example, the at least one processor 210 may execute an application for a camera. The at least one processor 210 may display an execution screen 1031 of the application for the camera via a display 220. The at least one processor 210 may identify whether the first security data 131 and the second security data 141 are the same, based on the user input 1033 for camera capture. As an example, the user input 1033 may be described as a touch input on a UI object 1032 for camera capture. For example, the at least one processor 210 may change a state of the electronic device 100 from state 1030 to the state 1040, based on identifying the first security data 131 different from the second security data 141.

For example, a system call invoked from a user-level program (e.g., the user-level program 810 of FIG. 8 or the application for the camera) may be invoked based on a reference time period, independently of a user input. For example, the system call may be invoked when a hardware resource (a camera or a touch screen) is used. For example, the at least one processor 210 may invoke the system call, based on accessing a first storage area 130 included in memory 150 for writing and/or reading. For example, the system call may be described as the event for the verification of the first security data 131.

In the state 1040, the at least one processor 210 may provide the notification representing the abnormal state of the first security data 131 by displaying a visual object 1041 representing the abnormal state of the first security data 131 via the display 220. For example, the at least one processor 210 may block execution of a function of a kernel 110 and/or a process in the kernel 110 related to the event for the verification of the first security data 131, while displaying the visual object 1041.

For example, in the state 1030, the at least one processor 210 may capture an external scene of the electronic device 100, in response to the user input 1033 for capture. For example, the application for the camera, which is a user-level program (e.g., the user-level program 810 of FIG. 8), may enter the kernel mode to use the camera which is hardware. For example, a system call may be invoked from the user-level program for entering the kernel mode. The at least one processor 210 may identify whether the first security data 131 and the second security data 141 are the same, based on identifying the system call.

As an example, the at least one processor 210 may capture the external scene of the electronic device 100 in the application for the camera, using the camera which is hardware, based on identifying the first security data 131 corresponding to the second security data 141.

As an example, the at least one processor 210 may block use of the camera which is hardware and capture of the external scene of the electronic device 100, based on identifying the first security data 131 different from the second security data 141. The at least one processor 210 may provide the notification representing the abnormal state of the first security data 131 by displaying the visual object 1041 representing the abnormal state of the first security data 131 via the display 220, based on identifying the first security data 131 different from the second security data 141.

For example, the at least one processor 210 may display the visual object 1041 including a first UI object 1042 and a second UI object 1043 via the display 220. For example, the at least one processor 210 may receive a user input with respect to the first UI object 1042 from among the first UI object 1042 and the second UI object 1043, while the visual object 1041 is being displayed. The at least one processor 210 may perform a reboot of the electronic device 100, in response to the user input on the first UI object 1042.

For example, the at least one processor 210 may receive a user input with respect to the second UI object 1043, while the visual object 1041 is being displayed. The at least one processor 210 may refrain from performing a reboot of the electronic device 100, in response to the user input on the second UI object 1043. The at least one processor 210 may skip a reboot of the electronic device 100, in response to the user input on the second UI object 1043. For example, the at least one processor 210 may defer a reboot of the electronic device 100, in response to the user input on the second UI object 1043.

For example, the at least one processor 210 may cease displaying the visual object 1041, in response to the user input on the second UI object 1043. The at least one processor 210 may provide a notification representing the abnormal state of the first security data 131 after a reference time (e.g., 1 minute), in response to the user input on the second UI object 1043. For example, the at least one processor 210 may perform a reboot of the electronic device 100, based on identifying that the number of user inputs on the second UI object 1043 exceeds a reference number (e.g., 10 times).

For example, the at least one processor 210 may initialize the first storage area 130, a second storage area 140, the first security data 131, the second security data 141, and information 142 representing an address of the first storage area 130 to which the first security data 131 is written, by performing the reboot of the electronic device 100.

For example, the at least one processor 210 may erase the first security data 131 written to the first storage area 130, in response to the user input on the second UI object 1043. For example, the at least one processor 210 may initialize the first security data 131, in response to the user input on the second UI object 1043. The at least one processor 210 may write third security data corresponding to the second security data 141 to the first storage area using the kernel 110. The at least one processor 210 may identify, using the kernel 110, information representing an address of the first storage area to which the third security data is written. The at least one processor 210 may write the information representing the address of the first storage area to which the third security data is written, to the second storage area 140, in conjunction with the second security data 141. As an example, the at least one processor 210 may update the security data and the information representing the address written to the second storage area, based on writing the third security data to the first storage area.

FIG. 11 is a block diagram illustrating an electronic device in a network environment according to an embodiment of the disclosure.

Referring to FIG. 11, an electronic device 1101 in a network environment 1100 may communicate with an external electronic device 1102 via a first network 1198 (e.g., a short-range wireless communication network), or at least one of an external electronic device 1104 or a server 1108 via a second network 1199 (e.g., a long-range wireless communication network). According to an embodiment of the disclosure, the electronic device 1101 may communicate with the external electronic device 1104 via the server 1108. According to an embodiment of the disclosure, the electronic device 1101 may include a processor 1120, memory 1130, an input module 1150, a sound output module 1155, a display module 1160, an audio module 1170, a sensor module 1176, an interface 1177, a connecting terminal 1178, a haptic module 1179, a camera module 1180, a power management module 1188, a battery 1189, a communication module 1190, a subscriber identification module (SIM) 1196, or an antenna module 1197. In some embodiments of the disclosure, at least one of the components (e.g., the connecting terminal 1178) may be omitted from the electronic device 1101, or one or more other components may be added in the electronic device 1101. In some embodiments of the disclosure, some of the components (e.g., the sensor module 1176, the camera module 1180, or the antenna module 1197) may be implemented as a single component (e.g., the display module 1160).

The processor 1120 may execute, for example, software (e.g., a program 1140) to control at least one other component (e.g., a hardware or software component) of the electronic device 1101 coupled with the processor 1120, and may perform various data processing or computation. According to an embodiment of the disclosure, as at least part of the data processing or computation, the processor 1120 may store a command or data received from another component (e.g., the sensor module 1176 or the communication module 1190) in volatile memory 1132, process the command or the data stored in the volatile memory 1132, and store resulting data in non-volatile memory 1134. According to an embodiment of the disclosure, the processor 1120 may include a main processor 1121 (e.g., a central processing unit (CPU) or an application processor (AP)), or an auxiliary processor 1123 (e.g., a graphics processing unit (GPU), a neural processing unit (NPU), an image signal processor (ISP), a sensor hub processor, or a communication processor (CP)) that is operable independently from, or in conjunction with, the main processor 1121. For example, when the electronic device 1101 includes the main processor 1121 and the auxiliary processor 1123, the auxiliary processor 1123 may be adapted to consume less power than the main processor 1121, or to be specific to a specified function. The auxiliary processor 1123 may be implemented as separate from, or as part of the main processor 1121.

The auxiliary processor 1123 may control at least some of functions or states related to at least one component (e.g., the display module 1160, the sensor module 1176, or the communication module 1190) among the components of the electronic device 1101, instead of the main processor 1121 while the main processor 1121 is in an inactive (e.g., a sleep) state, or together with the main processor 1121 while the main processor 1121 is in an active state (e.g., executing an application). According to an embodiment of the disclosure, the auxiliary processor 1123 (e.g., an image signal processor or a communication processor) may be implemented as part of another component (e.g., the camera module 1180 or the communication module 1190) functionally related to the auxiliary processor 1123. According to an embodiment of the disclosure, the auxiliary processor 1123 (e.g., the neural processing unit) may include a hardware structure specified for artificial intelligence model processing. An artificial intelligence model may be generated by machine learning. Such learning may be performed, e.g., by the electronic device 1101 where the artificial intelligence is performed or via a separate server (e.g., the server 1108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134.

The program 1140 may be stored in the memory 1130 as software, and may include, for example, an operating system (OS) 1142, middleware 1144, or an application 1146.

The input module 1150 may receive a command or data to be used by another component (e.g., the processor 1120) of the electronic device 1101, from the outside (e.g., a user) of the electronic device 1101. The input module 1150 may include, for example, a microphone, a mouse, a keyboard, a key (e.g., a button), or a digital pen (e.g., a stylus pen).

The sound output module 1155 may output sound signals to the outside of the electronic device 1101. The sound output module 1155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 1160 may visually provide information to the outside (e.g., a user) of the electronic device 1101. The display module 1160 may include, for example, a display, a hologram device, or a projector and control circuitry to control a corresponding one of the display, hologram device, and projector. According to an embodiment of the disclosure, the display module 1160 may include a touch sensor adapted to detect a touch, or a pressure sensor adapted to measure the intensity of force incurred by the touch.

The audio module 1170 may convert a sound into an electrical signal and vice versa. According to an embodiment of the disclosure, the audio module 1170 may obtain the sound via the input module 1150, or output the sound via the sound output module 1155 or a headphone of an external electronic device (e.g., the external electronic device 1102) directly (e.g., wiredly) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. According to an embodiment of the disclosure, the sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device (e.g., the external electronic device 1102) directly (e.g., wiredly) or wirelessly. According to an embodiment of the disclosure, the interface 1177 may include, for example, a high definition multimedia interface (HDMI), a universal serial bus (USB) interface, a secure digital (SD) card interface, or an audio interface.

A connecting terminal 1178 may include a connector via which the electronic device 1101 may be physically connected with the external electronic device (e.g., the external electronic device 1102). According to an embodiment of the disclosure, the connecting terminal 1178 may include, for example, an HDMI connector, a USB connector, an SD card connector, or an audio connector (e.g., a headphone connector).

The haptic module 1179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 1179 may include, for example, a motor, a piezoelectric element, or an electric stimulator.

The camera module 1180 may capture a still image or moving images. According to an embodiment of the disclosure, the camera module 1180 may include one or more lenses, image sensors, image signal processors, or flashes.

The power management module 1188 may manage power supplied to the electronic device 1101. According to an embodiment of the disclosure, the power management module 1188 may be implemented as at least part of, for example, a power management integrated circuit (PMIC).

The battery 1189 may supply power to at least one component of the electronic device 1101. According to an embodiment of the disclosure, the battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the external electronic device 1102, the external electronic device 1104, or the server 1108) and performing communication via the established communication channel. The communication module 1190 may include one or more communication processors that are operable independently from the processor 1120 (e.g., the application processor (AP)) and supports a direct (e.g., wired) communication or a wireless communication. According to an embodiment of the disclosure, the communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device via the first network 1198 (e.g., a short-range communication network, such as Bluetooth™, wireless-fidelity (Wi-Fi) direct, or infrared data association (IrDA)) or the second network 1199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The wireless communication module 1192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1192 may support a high-frequency band (e.g., the millimeter-wave (mmWave) band) to achieve, e.g., a high data transmission rate. The wireless communication module 1192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1192 may support various requirements specified in the electronic device 1101, an external electronic device (e.g., the external electronic device 1104), or a network system (e.g., the second network 1199). According to an embodiment of the disclosure, the wireless communication module 1192 may support a peak data rate (e.g., 20 Gbps or more) for implementing eMBB, loss coverage (e.g., 1164 dB or less) for implementing mMTC, or user plane (U-plane) latency (e.g., 0.5 ms or less for each of downlink (DL) and uplink (UL), or a round trip of 11 ms or less) for implementing URLLC.

The antenna module 1197 may transmit or receive a signal or power to or from the outside (e.g., the external electronic device) of the electronic device 1101. According to an embodiment of the disclosure, the antenna module 1197 may include an antenna including a radiating element including a conductive material or a conductive pattern formed in or on a substrate (e.g., a printed circuit board (PCB)). According to an embodiment of the disclosure, the antenna module 1197 may include a plurality of antennas (e.g., array antennas). In such a case, at least one antenna appropriate for a communication scheme used in the communication network, such as the first network 1198 or the second network 1199, may be selected, for example, by the communication module 1190 (e.g., the wireless communication module 1192) from the plurality of antennas. The signal or the power may then be transmitted or received between the communication module 1190 and the external electronic device via the selected at least one antenna. According to an embodiment of the disclosure, another component (e.g., a radio frequency integrated circuit (RFIC)) other than the radiating element may be additionally formed as part of the antenna module 1197.

According to various embodiments of the disclosure, the antenna module 1197 may form a mmWave antenna module. According to an embodiment of the disclosure, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 1101 and the external electronic device 1104 via the server 1108 coupled with the second network 1199. Each of the external electronic devices 1102 or 1104 may be a device of a same type as, or a different type, from the electronic device 1101. According to an embodiment of the disclosure, all or some of operations to be executed at the electronic device 1101 may be executed at one or more of the external electronic devices 1102 or 1104, or the server 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1101. The electronic device 1101 may provide the outcome, with or without further processing of the outcome, as at least part of a reply to the request. To that end, a cloud computing, distributed computing, mobile edge computing (MEC), or client-server computing technology may be used, for example. The electronic device 1101 may provide ultra low-latency services using, e.g., distributed computing or mobile edge computing. In another embodiment of the disclosure, the external electronic device 1104 may include an Internet-of-things (IoT) device. The server 1108 may be an intelligent server using machine learning and/or a neural network. According to an embodiment of the disclosure, the external electronic device 1104 or the server 1108 may be included in the second network 1199. The electronic device 1101 may be applied to intelligent services (e.g., a smart home, a smart city, a smart car, or healthcare) based on 5G communication technology or IoT-related technology.

According to an embodiment of the disclosure, an electronic device (e.g., the electronic device 100 of FIG. 1) is provided. The electronic device may comprise at least one processor (e.g., the processor 210 of FIG. 2) comprising processing circuitry. The electronic device may comprise memory (e.g., the memory 150 of FIG. 1) comprising one or more storage media storing instructions. The instructions, when executed by the at least one processor individually or collectively, may cause the electronic device to identify an event for verification of first security data (e.g., the first security data 131 of FIG. 1) written to a first storage area (e.g., the first storage area 130 of FIG. 1). The first storage area may be accessible by a kernel (e.g., the kernel 110 of FIG. 1) for reading and writing.

For example, the instructions, when executed by the at least one processor individually or collectively, may cause the electronic device to, based on the event, read, using the kernel, information (e.g., the information 142 representing an address of FIG. 1) representing an address of the first storage area to which the first security data is written and second security data (e.g., the second security data 141 of FIG. 1) which is reference data for verifying the first security data, from a second storage area (e.g., the second storage area 140 of FIG. 1). The second storage area may be accessible by the kernel for reading, and inaccessible by the kernel for writing.

For example, the instructions, when executed by the at least one processor individually or collectively, may read, based on the address represented by the information, the first security data from the first storage area using the kernel.

For example, the instructions, when executed by the at least one processor individually or collectively, may cause the electronic device to compare the second security data and the first security data for the verification of the first security data.

For example, the instructions, when executed by the at least one processor individually or collectively, may cause the electronic device to provide a notification representing an abnormal state of the first security data, based on identifying the first security data different from the second security data in accordance with the comparison.

For example, the event for the verification may include a system call invoked from a user-level program for requesting a function of the kernel and/or an event requesting a process in the kernel.

For example, the instructions, when executed by the at least one processor individually or collectively, may cause the electronic device to, in response to entering a kernel mode based on the system call invoked for requesting the function of the kernel, read the information and the second security data from the second storage area for the verification of the first security data which may be used in the kernel mode.

For example, the instructions, when executed by the at least one processor individually or collectively, may cause the electronic device to read the first security data from the first storage area using the address.

For example, the instructions, when executed by the at least one processor individually or collectively, may cause the electronic device to compare the second security data and the first security data.

For example, the instructions, when executed by the at least one processor individually or collectively, may cause the electronic device to execute at least one function in the kernel mode, based on identifying the first security data corresponding to the second security data in accordance with the comparison.

For example, the instructions, when executed by the at least one processor individually or collectively, may cause the electronic device to block executing at least one function in the kernel mode and provide the notification, based on identifying the first security data different from the second security data in accordance with the comparison.

For example, the instructions, when executed by the at least one processor individually or collectively, may cause the electronic device to read the information and the second security data from the second storage area for the verification of the first security data before exiting a kernel mode entered based on the system call invoked for requesting the function of the kernel.

For example, the instructions, when executed by the at least one processor individually or collectively, may cause the electronic device to read the first security data from the first storage area using the address.

For example, the instructions, when executed by the at least one processor individually or collectively, may cause the electronic device to compare the second security data and the first security data.

For example, the instructions, when executed by the at least one processor individually or collectively, may cause the electronic device to exit the kernel mode, based on identifying the first security data corresponding to the second security data in accordance with the comparison.

For example, the instructions, when executed by the at least one processor individually or collectively, may cause the electronic device to provide the notification, based on identifying the first security data different from the second security data in accordance with the comparison.

For example, the instructions, when executed by the at least one processor individually or collectively, may cause the electronic device to identify that the first security data written to the first storage area is used for execution of the process, before the process is executed, based on the event requesting the process in the kernel.

For example, the instructions, when executed by the at least one processor individually or collectively, may cause the electronic device to, based on identifying that the first security data is used for execution of the process, read, using the kernel, the information representing the address of the first storage area and the second security data for verifying the first security data from the second storage area for the verification of the first security data.

For example, the instructions, when executed by the at least one processor individually or collectively, may cause the electronic device to read the first security data from the first storage area using the kernel, based on the address represented by the information.

For example, the instructions, when executed by the at least one processor individually or collectively, may cause the electronic device to compare the second security data and the first security data for the verification of the first security data.

For example, the instructions, when executed by the at least one processor individually or collectively, may cause the electronic device to execute the process in the kernel, based on identifying the first security data corresponding to the second security data in accordance with the comparison.

For example, the instructions, when executed by the at least one processor individually or collectively, may cause the electronic device to block executing the process in the kernel and provide a notification representing the abnormal state of the first security data, based on identifying the first security data different from the second security data in accordance with the comparison.

For example, the instructions, when executed by the at least one processor individually or collectively, may cause the electronic device to erase the first security data written to the first storage area, based on identifying the first security data different from the second security data in accordance with the comparison.

For example, the instructions, when executed by the at least one processor individually or collectively, may cause the electronic device to write third security data corresponding to the second security data to the first storage area using the kernel.

For example, the instructions, when executed by the at least one processor individually or collectively, may cause the electronic device to identify, using the kernel, information representing an address of the first storage area to which the third security data is written.

For example, the instructions, when executed by the at least one processor individually or collectively, may cause the electronic device to write the information representing the address of the first storage area to which the third security data is written, to the second storage area, in conjunction with the second security data.

For example, the instructions, when executed by the at least one processor individually or collectively, may cause the electronic device to perform a reboot of the electronic device based on identifying the first security data different from the second security data in accordance with the comparison.

For example, the electronic device may further comprise a display. The instructions, when executed by the at least one processor individually or collectively, may cause the electronic device to provide the notification by displaying, via the display, a visual object representing the abnormal state of the first security data, based on identifying the first security data different from the second security data in accordance with the comparison.

For example, the visual object may include a first user interface (UI) object and a second UI object. The instructions, when executed by the at least one processor individually or collectively, may cause the electronic device to, while the visual object is being displayed, perform a reboot of the electronic device based on a user input received with respect to the first UI object from among the first UI object and the second UI object.

For example, the instructions, when executed by the at least one processor individually or collectively, may cause the electronic device to, while the visual object is being displayed, refrain from performing the reboot of the electronic device based on a user input received with respect to the second UI object from among the first UI object and the second UI object.

For example, the verification may include identification of integrity of the first security data and/or authentication of the first security data.

For example, the information representing the address of the first storage area to which the first security data is written may include information on a starting address of the first security data written to the first storage area and information on a size of the first security data.

For example, the instructions, when executed by the at least one processor individually or collectively, may cause the electronic device to identify an event for writing the first security data.

For example, the instructions, when executed by the at least one processor individually or collectively, may cause the electronic device to write the first security data to the first storage area using the kernel based on the event for writing the first security data.

For example, the instructions, when executed by the at least one processor individually or collectively, may cause the electronic device to identify, using the kernel, the information representing the address of the first storage area to which the first security data is written.

For example, the instructions, when executed by the at least one processor individually or collectively, may cause the electronic device to write the second security data and the information representing the address of the first storage area to which the first security data is written, to the second storage area, using security software capable of accessing the second storage area for reading and writing.

For example, the instructions, when executed by the at least one processor individually or collectively, may cause the electronic device to identify the event for the verification of the first security data after the first security data is written to the first storage area and the second security data and the information are written to the second storage area.

For example, the security software may be a hypervisor.

According to an embodiment of the disclosure, an electronic device is provided. The electronic device may comprise at least one processor comprising processing circuitry. The electronic device may comprise memory comprising one or more storage media storing instructions. The instructions, when executed by the at least one processor individually or collectively, may cause the electronic device to identify an event for writing security data.

For example, the instructions, when executed by the at least one processor individually or collectively, may cause the electronic device to, based on the event, write the security data to a first storage area accessible by a kernel for reading and writing, using the kernel.

For example, the instructions, when executed by the at least one processor individually or collectively, may cause the electronic device to identify, using the kernel, information representing an address of the first storage area to which the security data is written.

For example, the instructions, when executed by the at least one processor individually or collectively, may cause the electronic device to write the security data and the information to a second storage area which is accessible by the kernel for reading and inaccessible by the kernel for writing, using security software capable of accessing the second storage area for reading and writing, to verify the security data written to the first storage area.

For example, the instructions, when executed by the at least one processor individually or collectively, may cause the electronic device to request writing, using the security software, the security data and the information to the second storage area based on attempting to write the security data and the information to the second storage area using the kernel, and failing to write the security data and the information to the second storage area in accordance with the attempt.

For example, the instructions, when executed by the at least one processor individually or collectively, may cause the electronic device to, based on the request, write, using the security software, the security data and the information to the second storage area to verify the security data written to the first storage area.

For example, the security data written to the first storage area may be first security data, and the security data written to the second storage area may be second security data.

For example, the instructions, when executed by the at least one processor individually or collectively, may cause the electronic device to identify an event for verification of the first security data based on the second security data and the information written to the second storage area.

For example, the instructions, when executed by the at least one processor individually or collectively, may cause the electronic device to read, using the kernel, the second security data and the information from the second storage area, based on the event for the verification.

For example, the instructions, when executed by the at least one processor individually or collectively, may cause the electronic device to read, using the kernel, the first security data from the first storage area based on the address represented by the information.

For example, the instructions, when executed by the at least one processor individually or collectively, may cause the electronic device to compare the second security data and the first security data to verify the first security data.

For example, the instructions, when executed by the at least one processor individually or collectively, may cause the electronic device to provide a notification representing an abnormal state of the first security data, based on identifying the first security data different from the second security data in accordance with the comparison.

According to an embodiment of the disclosure, a non-transitory computer readable storage medium storing one or more programs is provided. The one or more programs may include instructions which, when executed by at least one processor of an electronic device, cause the electronic device to identify an event for verification of first security data written to a first storage area. The first storage area may be accessible by a kernel for reading and writing.

For example, the one or more programs may include instructions which, when executed by the at least one processor, cause the electronic device to, based on the event, read, using the kernel, information representing an address of the first storage area to which the first security data is written and second security data which is reference data for verifying the first security data, from a second storage area. The second storage area may be accessible by the kernel for reading, and inaccessible by the kernel for writing.

For example, the one or more programs may include instructions which, when executed by the at least one processor, cause the electronic device to read, based on the address represented by the information, the first security data from the first storage area using the kernel.

For example, the one or more programs may include instructions which, when executed by the at least one processor, cause the electronic device to compare the second security data and the first security data for the verification of the first security data.

For example, the one or more programs may include instructions which, when executed by the at least one processor, cause the electronic device to provide a notification representing an abnormal state of the first security data, based on identifying the first security data different from the second security data in accordance with the comparison.

According to an embodiment of the disclosure, a non-transitory computer readable storage medium storing one or more programs is provided. The one or more programs may include instructions which, when executed by at least one processor of an electronic device, cause the electronic device to identify an event for writing security data. The one or more programs may include instructions which, when executed by the at least one processor, cause the electronic device to, based on the event, write the security data to a first storage area accessible by a kernel for reading and writing, using the kernel.

For example, the one or more programs may include instructions which, when executed by the at least one processor, cause the electronic device to identify, using the kernel, information representing an address of the first storage area to which the security data is written.

For example, the one or more programs may include instructions which, when executed by the at least one processor, cause the electronic device to write the security data and the information to a second storage area which is accessible by the kernel for reading and inaccessible by the kernel for writing, using security software capable of accessing the second storage area for reading and writing, to verify the security data written to the first storage area.

For example, the event for the verification may include a system call invoked from a user-level program for requesting a function of the kernel and/or an event requesting a process in the kernel.

For example, the one or more programs may include instructions which, when executed by the at least one processor, cause the electronic device to, in response to entering a kernel mode based on the system call invoked for requesting the function of the kernel, read the information and the second security data from the second storage area for the verification of the first security data which may be used in the kernel mode.

For example, the one or more programs may include instructions which, when executed by the at least one processor, cause the electronic device to read the first security data from the first storage area using the address.

For example, the one or more programs may include instructions which, when executed by the at least one processor, cause the electronic device to compare the second security data and the first security data.

For example, the one or more programs may include instructions which, when executed by the at least one processor, cause the electronic device to execute at least one function in the kernel mode, based on identifying the first security data corresponding to the second security data in accordance with the comparison.

For example, the one or more programs may include instructions which, when executed by the at least one processor, cause the electronic device to block executing at least one function in the kernel mode and provide the notification, based on identifying the first security data different from the second security data in accordance with the comparison.

For example, the one or more programs may include instructions which, when executed by the at least one processor, cause the electronic device to read the information and the second security data from the second storage area for the verification of the first security data before exiting a kernel mode entered based on the system call invoked for requesting the function of the kernel.

For example, the one or more programs may include instructions which, when executed by the at least one processor, cause the electronic device to read the first security data from the first storage area using the address.

For example, the one or more programs may include instructions which, when executed by the at least one processor, cause the electronic device to compare the second security data and the first security data.

For example, the one or more programs may include instructions which, when executed by the at least one processor, cause the electronic device to exit the kernel mode, based on identifying the first security data corresponding to the second security data in accordance with the comparison.

For example, the one or more programs may include instructions which, when executed by the at least one processor, cause the electronic device to provide the notification, based on identifying the first security data different from the second security data in accordance with the comparison.

According to an embodiment of the disclosure, a method performed by an electronic device is provided. The method may comprise identifying an event for verification of first security data written to a first storage area. The first storage area may be accessible by a kernel for reading and writing.

For example, the method may comprise reading, based on the event, using the kernel, information representing an address of the first storage area to which the first security data is written and second security data which is reference data for verifying the first security data, from a second storage area. The second storage area may be accessible by the kernel for reading, and inaccessible by the kernel for writing.

For example, the method may comprise reading, based on the address represented by the information, the first security data from the first storage area using the kernel.

For example, the method may comprise comparing the second security data and the first security data for the verification of the first security data.

For example, the method may comprise providing a notification representing an abnormal state of the first security data, based on identifying the first security data different from the second security data in accordance with the comparison.

According to an embodiment of the disclosure, a method performed by an electronic device is provided. The method may comprise identifying an event for writing security data.

For example, the method may comprise writing, based on the event, the security data to a first storage area accessible by a kernel for reading and writing, using the kernel.

For example, the method may comprise identifying, using the kernel, information representing an address of the first storage area to which the security data is written.

For example, the method may comprise writing the security data and the information to a second storage area which is accessible by the kernel for reading and inaccessible by the kernel for writing, using security software capable of accessing the second storage area for reading and writing, to verify the security data written to the first storage area.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 1140) including one or more instructions that are stored in a storage medium (e.g., internal memory 1136 or external memory 1138) that is readable by a machine (e.g., the electronic device 1101). For example, a processor (e.g., the processor 1120) of the machine (e.g., the electronic device 1101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory, comprising one or more storage media, storing instructions; and
at least one processor, comprising processing circuitry, communicatively coupled to the memory,
wherein the instructions, when executed by the at least one processor individually or collectively, cause the electronic device to:
identify an event for verification of first security data written to a first storage area, wherein the first storage area is accessible by a kernel for reading and writing,
based on the event, read, using the kernel, information representing an address of the first storage area to which the first security data is written and second security data which is reference data for verifying the first security data, from a second storage area, wherein the second storage area is accessible by the kernel for reading, and inaccessible by the kernel for writing,
read, based on the address represented by the information, the first security data from the first storage area using the kernel,
compare the second security data and the first security data for the verification of the first security data, and
based on identifying the first security data different from the second security data in accordance with comparison, provide a notification representing an abnormal state of the first security data.

2. The electronic device of claim 1, wherein the event for the verification includes a system call invoked from a user-level program for requesting a function of the kernel and/or an event requesting a process in the kernel.

3. The electronic device of claim 2, wherein the instructions, when executed by the at least one processor individually or collectively, further cause the electronic device to:
in response to entering a kernel mode, based on the system call invoked for requesting the function of the kernel, read the information and the second security data from the second storage area for the verification of the first security data which can be used in the kernel mode,
read the first security data from the first storage area using the address,
compare the second security data and the first security data,
based on identifying the first security data corresponding to the second security data in accordance with the comparison, execute at least one function in the kernel mode, and
based on identifying the first security data different from the second security data in accordance with the comparison, block executing at least one function in the kernel mode, and provide the notification.

4. The electronic device of the claim 2, wherein the instructions, when executed by the at least one processor individually or collectively, further cause the electronic device to:
read the information and the second security data from the second storage area for the verification of the first security data before exiting a kernel mode entered based on the system call invoked for requesting the function of the kernel,
read the first security data from the first storage area using the address,
compare the second security data and the first security data,
exit the kernel mode based on identifying the first security data corresponding to the second security data in accordance with the comparison, and
provide the notification based on identifying the first security data different from the second security data in accordance with the comparison.

5. The electronic device of claim 2, wherein the instructions, when executed by the at least one processor individually or collectively, further cause the electronic device to:
identify that the first security data written to the first storage area is used for execution of the process, before the process is executed, based on the event requesting the process in the kernel,
based on identifying that the first security data is used for execution of the process, read, using the kernel, the information representing the address of the first storage area and the second security data for verifying the first security data from the second storage area for the verification of the first security data,
read the first security data from the first storage area using the kernel, based on the address represented by the information,
compare the second security data and the first security data for the verification of the first security data,
based on identifying the first security data corresponding to the second security data in accordance with the comparison, execute the process in the kernel, and
based on identifying the first security data different from the second security data in accordance with the comparison, block executing the process in the kernel and provide a notification representing the abnormal state of the first security data.

6. The electronic device of claim 1, wherein the instructions, when executed by the at least one processor individually or collectively, further cause the electronic device to:
based on identifying the first security data different from the second security data in accordance with the comparison, erase the first security data written to the first storage area,
write third security data corresponding to the second security data to the first storage area using the kernel,
identify, using the kernel, information representing an address of the first storage area to which the third security data is written, and
write the information representing the address of the first storage area to which the third security data is written, to the second storage area, in conjunction with the second security data.

7. The electronic device of claim 1, wherein the instructions, when executed by the at least one processor individually or collectively, further cause the electronic device to:
perform a reboot of the electronic device based on identifying the first security data different from the second security data in accordance with the comparison.

8. The electronic device of claim 1, further comprising:
a display,
wherein the instructions, when executed by the at least one processor individually or collectively, further cause the electronic device to:
based on identifying the first security data different from the second security data in accordance with the comparison, provide the notification by displaying, via the display, a visual object representing the abnormal state of the first security data.

9. The electronic device of claim 8,
wherein the visual object includes a first user interface (UI) object and a second UI object, and
wherein the instructions, when executed by the at least one processor individually or collectively, further cause the electronic device to:
while the visual object is being displayed, perform a reboot of the electronic device based on a user input received with respect to the first UI object from among the first UI object and the second UI object, and
while the visual object is being displayed, refrain from performing the reboot of the electronic device based on a user input received with respect to the second UI object from among the first UI object and the second UI object.

10. The electronic device of claim 1, wherein the verification includes identification of integrity of the first security data and/or authentication of the first security data.

11. The electronic device of claim 1, wherein the information representing the address of the first storage area to which the first security data is written includes information on a starting address of the first security data written to the first storage area and information on a size of the first security data.

12. The electronic device of claim 1, wherein the instructions, when executed by the at least one processor individually or collectively, further cause the electronic device to:
identify an event for writing the first security data,
write the first security data to the first storage area using the kernel based on the event for writing the first security data,
identify, using the kernel, the information representing the address of the first storage area to which the first security data is written,
write, using security software capable of accessing the second storage area for reading and writing, the second security data and the information representing the address of the first storage area to which the first security data is written, to the second storage area, and
identify the event for the verification of the first security data after the first security data is written to the first storage area and the second security data and the information are written to the second storage area.

13. The electronic device of claim 12, wherein the security software is a hypervisor.

14. An electronic device comprising:
memory, comprising one or more storage media, storing instructions; and
at least one processor, comprising processing circuitry, communicatively coupled to the memory,
wherein the instructions, when executed by the at least one processor individually or collectively, cause the electronic device to:
identify an event for writing security data,
based on the event, write the security data to a first storage area accessible by a kernel for reading and writing, using the kernel,
identify, using the kernel, information representing an address of the first storage area to which the security data is written, and
write, using security software capable of accessing the second storage area for reading and writing, the security data and the information to a second storage area which is accessible by the kernel for reading and inaccessible by the kernel for writing to verify the security data written to the first storage area.

15. The electronic device of claim 14, wherein the instructions, when executed by the at least one processor individually or collectively, further cause the electronic device to:
request writing, using the security software, the security data and the information to the second storage area based on:
attempting to write the security data and the information to the second storage area using the kernel, and
failing to write the security data and the information to the second storage area in accordance with the attempt; and
based on the request, write, using the security software, the security data and the information to the second storage area to verify the security data written to the first storage area.

16. The electronic device of claim 14,
wherein the security data written to the first storage area is first security data,
wherein the security data written to the second storage area is second security data, and
wherein the instructions, when executed by the at least one processor individually or collectively, further cause the electronic device to:
identify an event for verification of the first security data based on the second security data and the information written to the second storage area,
read, using the kernel, the second security data and the information from the second storage area based on the event for the verification,
read, using the kernel, the first security data from the first storage area based on the address represented by the information,
compare the second security data and the first security data to verify the first security data, and
based on identifying the first security data different from the second security data in accordance with the comparison, provide a notification representing an abnormal state of the first security data.

17. One or more non-transitory computer readable storage media storing one or more computer programs including computer-executable instructions that, when executed by at least one processor of an electronic device individually or collectively, cause the electronic device to perform operations, the operations comprising:
identifying an event for verification of first security data written to a first storage area, wherein the first storage area is accessible by a kernel for reading and writing;
based on the event, reading, using the kernel, information representing an address of the first storage area to which the first security data is written and second security data which is reference data for verifying the first security data from a second storage area, wherein the second storage area is accessible by the kernel for reading, and inaccessible by the kernel for writing;
reading, based on the address represented by the information, the first security data from the first storage area using the kernel;
comparing the second security data and the first security data for the verification of the first security data; and
based on identifying the first security data different from the second security data in accordance with comparison, providing a notification representing an abnormal state of the first security data.

18. The one or more non-transitory computer readable storage media of claim 17, wherein the event for the verification includes a system call invoked from a user-level program for requesting a function of the kernel and/or an event requesting a process in the kernel.

19. The one or more non-transitory computer readable storage media of claim 18, the operations further comprising:
in response to entering a kernel mode, based on the system call invoked for requesting the function of the kernel, reading the information and the second security data from the second storage area for the verification of the first security data which can be used in the kernel mode;
reading the first security data from the first storage area using the address;
comparing the second security data and the first security data;
based on identifying the first security data corresponding to the second security data in accordance with the comparison, executing at least one function in the kernel mode; and
based on identifying the first security data different from the second security data in accordance with the comparison, blocking executing at least one function in the kernel mode, and provide the notification.

20. The one or more non-transitory computer readable storage media of claim 18, the operations further comprising:
reading the information and the second security data from the second storage area for the verification of the first security data before exiting a kernel mode entered based on the system call invoked for requesting the function of the kernel;
reading the first security data from the first storage area using the address;
comparing the second security data and the first security data;
exiting the kernel mode based on identifying the first security data corresponding to the second security data in accordance with the comparison; and
providing the notification based on identifying the first security data different from the second security data in accordance with the comparison.
